(19) United States
(12) Patent Application Publication
(10) Pub. No.: US 2018/0194607 A1
(43) Pub. Date: Jul. 12, 2018

(54) BEVERAGE DISPENSING SYSTEM

(71) Applicant: Miavina LLC, Miami, FL (US)

(72) Inventor: Cindy Diffenderfer, Miami Beach, FL (US)

(21) Appl. No.: 15/914,890

(22) Filed: Mar. 7, 2018

Related U.S. Application Data
(63) Continuation of application No. 14/959,656, filed on Dec. 4, 2015, now Pat. No. 9,963,338.
(60) Provisional application No. 62/088,082, filed on Dec. 5, 2014.

(51) Int. Cl. B67D 1/08; B67D 3/00; B67D 1/04; B67D 1/00; B67D 1/12

(52) U.S. Cl. CPC B67D 1/0884; B67D 2210/00091; B67D 1/0406; B67D 1/0857; B67D 1/0877; B67D 1/0882; B67D 3/0096; B67D 3/0083; B67D 3/0029; B67D 3/0022; B67D 3/0009; B67D 1/0004; B67D 1/1229; B67D 1/0895; B67D 1/0889; B67D 1/0888; B67D 1/0885; B67D 2001/0481; B67D 2001/0811; B67D 2001/1263; B67D 2210/00089; B67D 3/0006

(57) ABSTRACT

A liquid dispensing system is disclosed. The liquid system includes a housing, a vessel fluidly connected to the housing and containing a liquid, a preservation subsystem positioned within the housing and in fluid communication with the vessel and a liquid outlet operably connected to the housing and in fluid communication with the vessel. In operation, the preservation subsystem reduces oxidization of the fluid within the vessel, while allowing the fluid to be dispensed through the liquid outlet.

### CROSS REFERENCE TO RELATED APPLICATIONS

This application is a continuation of U.S. patent application Ser. No. 14/959,656, entitled “System and Method for Pouring Wine by the Glass,” filed Dec. 4, 2015, which claims the benefit, under 35 U.S.C. § 119(e), of U.S. Provisional Patent Application No. 62/088,082, filed Dec. 5, 2014, the disclosures of which are hereby incorporated herein in their entireties.

### FIELD OF THE INVENTION

Embodiments of the invention relate to various beverage dispensing systems and apparatuses.

### BACKGROUND

Wine begins to oxidize the moment the package is opened resulting in large amounts of spoiled or lost liquid. The current bottle packing is cumbersome and inefficient creating large amounts unnecessary waste. Producers have no visibility of consumer behavior and real time consumption making it impossible for them to both properly project and produce the appropriate volume of product resulting in inefficient farming practices and over-production. Until recently, it has been illegal to ship wine direct-to-consumer creating expensive, laborious and inefficient distribution methods.

### SUMMARY

Embodiments disclosed herein relate to a system and method for pouring wine-by-the glass on tap in a self contained, temperature controlled dispensing system. Liquid is extracted through a gas propulsion or gravity and suction method eliminating the introduction of oxygen creating a perfect environment for stable storage and extending the shelf life of liquid for prolonged optimal consumption.

One embodiment of the system includes both cooling and warming elements to properly control the temperature of liquid as prescribed by either the preset information in an IOT (Internet of Things) library or adjusted to taste by the user. The system has two chambers, offering dual-zone temperature settings and allowing the use of two types of wines (e.g., white and red) to be simultaneously served at respective unique temperatures. The system has a PCB board, which is the brain of the system, that will read information from each of the disclosed subsystems including: weight, depletion rates, temperature, UCC/RFID information and track consumption behavior. The PCB board will transmit information gathered to a cloud computing monitoring software application via a Wi-Fi connection, which will then be updated in each user's application when connected via a wireless device.

The purchasing, consumption and feedback behavior provided by each user will be monitored and interpreted to make curated selections and recommendations for each user based on their interactions with both the application and the system. A bay sensor subsystem will monitor depletion rates and prompt the user for real-time replenishment to ensure that the user never runs out of wine. The QR/UCC reader will identify each new item that enters the system and automatically sets each chamber to the products' ideal pouring temperature. The information transmitted by the PCB board from each system will be aggregated via the Cloud using data inputs such as e.g., age, gender, geographic location, weather, etc., allowing a provider to intelligently target a consumer base for sales, marketing and product introductions.

The disclosed embodiments are intended for both commercial use on premise at bars and restaurants and for in-home consumer use.

Wine dispensed by the system may be packaged in a proprietary container, referred to herein as a Quartina. The Quartina has a unique valve system that preserves the liquid while dispensing and eliminating the introduction of oxygen into the chamber, extending stabilized shelf life for storage when not in use. The valve system will have one point of entry and one point of exit—gas or limited oxygen in and liquid out. As the tap handle is engaged on the selected chamber, the valve is opened allowing the release of liquid from it's package and displacement with either gas or oxygen or collapse of an inner lining (depending on the vessel). The liquid then travels from the package, through the temperature controlled lines, through the faucet, into the glass. As the liquid is released, the Weigh system in the bay sensors subsystem calculates volume of liquid released and updates the PCB with new inventory levels. This information is transmitted back to the cloud monitoring application and then to the user application to update their immediate new inventory levels. The elimination and minimization of oxygen both into the chamber of each vessel as well as the exposed surface area extends the shelf life of the product for days and weeks at a time. Environmental and human factors will effect the amount of time the product is extended, but it is expected that it will range from 7-10 days for a bottle and about 30 days for a Quartina (as measured from the initial date of opening).

Another embodiment disclosed herein uses a gas-charged system comprising a small chamber of nitrogen gas in addition to other subsystems disclosed herein. The gas will be used as an additional method of liquid preservation by creating a layer of gas over the liquid to protect any surface area from being exposed to oxygen.

In yet another embodiment, a liquid dispensing system is disclosed. The liquid dispensing system includes a housing; a vessel fluidly connected to the housing and containing a liquid; a preservation subsystem positioned within the housing and in fluid communication with the vessel, wherein the preservation subsystem reduces oxidation of the liquid within the vessel; and a liquid outlet operably connected to the housing and in fluid communication with the vessel.

In yet another embodiment, a fluid dispensing system is disclosed. The system includes a housing; a container holding a fluid and coupled to the housing; a fluid-propulsion subsystem operably connected to the housing; and a fluid line in fluid communication with the container and the fluid-propulsion subsystem; a temperature sensor coupled to the fluid line and operable to detect a current temperature of the liquid; a temperature modification subsystem operably coupled to the housing; a computing subsystem in electrical communication with the temperature sensor and the temperature modification subsystem; and a dispenser in fluid communication with the fluid line; wherein the computing subsystem activates the temperature modification subsystem to adjust a temperature of the liquid when the current temperature does not match a desired temperature; and when the dispenser is activated, the fluid-propulsion system propels the fluid from the container to the dispenser.

In a further embodiment, a liquid preservation and dispensing system is disclosed. The system includes a container holding a liquid; a vessel, wherein the vessel receives and engages with the container, wherein the engagement prevents oxygen from contacting the liquid; a gas inlet valve on the container that enables a gas to enter the container when the inlet valve is in an open position; a liquid outlet valve on the container that enables the liquid to leave the container when the outlet valve is in an open position; a handle operably connected to the inlet and outlet valves, wherein the handle opens or closes the inlet and outlet valves; and a dispenser in fluid communication with the container, wherein the dispenser receives the liquid and introduces the liquid to oxygen.

### BRIEF DESCRIPTION OF THE DRAWINGS

FIG. 1 illustrates an example system in accordance with a disclosed embodiment.

FIG. 1a is an illustration of an embodiment of the system using a gravity feed and pump for preservation and propulsion.

FIG. 1b is an illustration of the disclosed magic cork as applied to a traditional wine bottle.

FIG. 1c is an illustration of the disclosed Quartina.

FIG. 2 illustrates the exterior view of one embodiment of the system.

FIG. 3 is an illustration of an example software application and its interactive features as disclosed herein.

FIG. 4 is an illustration of technology features included in at least one embodiment of the disclosed system.

FIG. 5 is an illustration of sample features of at least one embodiment of the disclosed system.

FIG. 6 is an illustration of an embodiment of the system using nitrogen gas for preservation and propulsion.

FIG. 7 is the side view of an example Quartina used in the FIG. 6 system.

### DETAILED DESCRIPTION

In the following detailed description, a plurality of specific details, such as types of materials and dimensions, are set forth in order to provide a thorough understanding of the preferred embodiments discussed below. The details discussed in connection with the preferred embodiments should not be understood to limit the claimed invention. Furthermore, for ease of understanding, certain method steps are delineated as separate steps; however, these steps should not be construed as necessarily distinct nor order dependent in their performance.

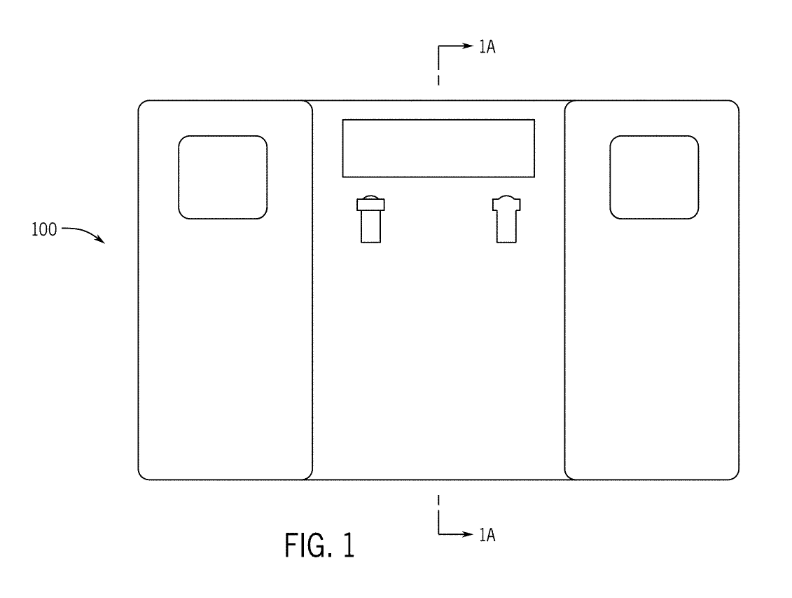

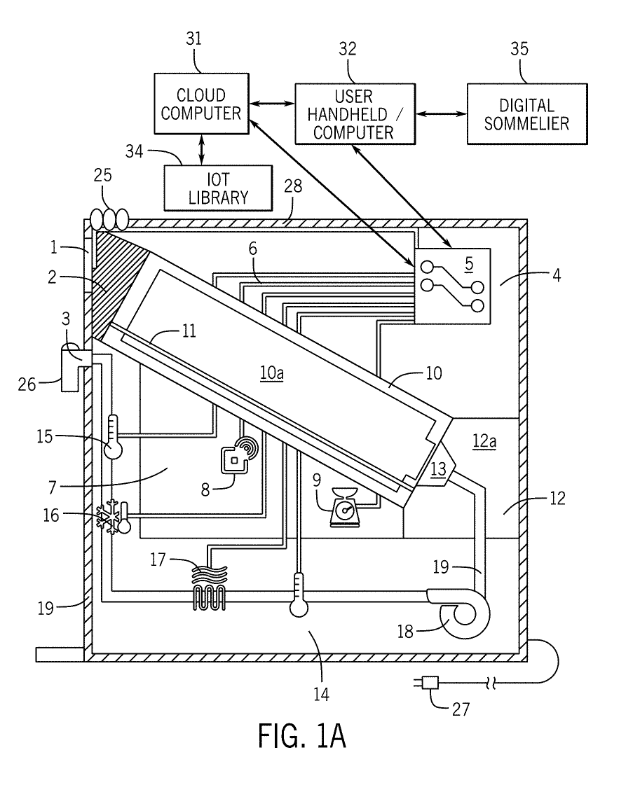

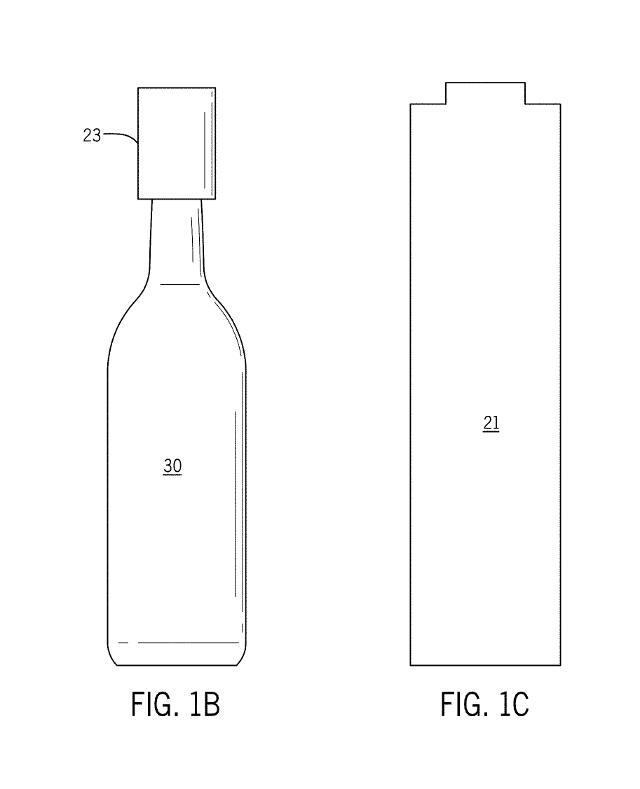

FIGS. 1-5 show a system 100 of a first example embodiment disclosed herein. The illustrated system 100 comprises multiple subsystems: PCB subsystem 4, bay sensors subsystem 7, vessel bay rail subsystem 10, vessel dock subsystem 12, fluid line subsystem 14, and vessel subsystems 20, 22 housed in a housing or casing 28. An information display 1 and dispenser 3 are mounted on or attached to the housing. In the illustrated embodiment, the dispenser 3 comprises two spouts, each to be connected to a respective vessel (via the fluid line subsystem 14). It should be appreciated that the dispenser 3 would have a lever or other mechanism for activating the dispenser so that liquid would be dispensed from the spouts. A vessel entrance 2 is also provided through the housing. The components within the housing may be powered by standard electricity via a power cord 27.

The PCB subsystem 4 comprises a PCB Board 5 and connections 6 that transmit via wireless connectivity 44 to a computer/application 31 connected e.g., via the cloud (i.e., Internet). The PCB subsystem 4 is the brain of the system 100, acting as a computing subsystem, and optionally including one or more processors or processing elements and memory storage. The PCB subsystem 4 performs and/or coordinates the functions disclosed herein and, in one embodiment, is a single printed circuit board 5 no larger than 100 square inches. In one embodiment, the PCB board 5 is located high and to the back of the system's housing for easy access to non-visible venting.

The bay sensors subsystem 7 comprises a QR/UCC sensor 8 and a weight sensor 9. The sensors in the bay sensors subsystem 7 allow the system 100 to recognizes fluid vessels introduced therein. Two sets of the sensors will be mounted on or immediately near the vessel bay subsystem 10. In one embodiment, QR/UCC sensor 8 is a QR/UCC code optical reader. In another embodiment, QR/UCC sensor 8 is an RFID sensor. Regardless of how implemented, the QR/UCC sensor 8 identifies the contents of fluid vessels introduced within the system 100. The weight sensor 9 may be a load cell or similar device to accurately measure the change in weight of fluid vessels.

The vessel bay rail subsystem 10 comprises the rail 11 and vessel bay 10a. The vessel bay 10a is a receptive mechanism that extends out to receive the fluid vessel. It may feature a combination of translational and rotational mechanisms made from either plastic, stamped steel or aluminum.

The vessel dock subsystem 12 comprises a vessel dock 12a. The vessel dock 12a is a stationary subassembly that presents a valve 13, referred to herein as a “magic valve”, to be mated with an adapter 23, referred to herein as a “magic cork”, found on the fluid vessel (discussed in more detail below). When the “magic” devices 13, 23 are mated, they will form a water-tight connection that will allow wine to be extracted. Together, the “magic” devices 13, 23 may be cylindrical in shape about 2 inches in diameter and about 3-4 inches in height.

The fluid line subsystem 14 includes one or more fluid lines 19, temperature sensors 15, temperature modification elements (e.g., cooling pads 16, warming pad 17), and an in-line pump 18. This subsystem 14 exists downstream from the vessel dock subsystem 12 and extends to include the dispenser 3. It should be appreciated the vessel dock subsystem 12 and its vessel dock 12a could be considered part of this subsystem 14. Likewise, the fluid line subsystem 14 could be considered to be part of the vessel dock subsystem 12. This subsystem 14 includes fluid lines 19 that may be e.g., two sets of food grade plastics suitable for wine or they may be stainless steel lines. These lines 19 are independent until connected to the dispenser 3. The temperature sensors 15 may be e.g., two pairs of fluid temperature sensors to help control wine temperature. The cooling pad 16 may be e.g., two sets of thermos electric cooling pads (TEC), roughly about sixteen square inches in area and about an inch in height. The warming pad 17 may be e.g., two sets of line heat traces. The pump 18 may be e.g., two sets of food grade plastic or stainless steel pumps.

The vessel subsystems 20, 22 are provided for accepting fluid vessels into the system 100 housing. The system 100 shall accommodate two or more different types of fluid vessels. A wine bottle 30 will require a manual application of the “magic cork” 23 to interface with the “magic valve” 13. The Quartina 21, on the other hand, is equipped with the appropriate adapter/magic cork and is designed to interface with the “magic valve” 13 without additional changes, etc. The Quartina 21 is a fluid vessel that may be a partially or wholly sourced “bag in a box” solution. The magic cork 23 shall provide a uniform mate to the vessel dock subsystem 12 regardless of fluid vessel.

In order to use the system 100, the user will follow the steps as detailed below for each unique new package opened. Initially, the user opens the Quartina 21 or bottle 30 to be introduced into the system 100. If using a Quartina 21, the user will remove a plastic seal and then open the front cover 19 to expose the vessel entrance 2 in the housing. The user will insert the Quartina 21 top down on a slopping vertical angle along the vessel bay subsystem 10 and rail 11. The Quartina 21 will slide along the rail 11 to a resting place at the bottom of the vessel dock 12.

Similarly, if using a bottle 30, the user will uncork the bottle 30 and replace the cork and/or twist cap with a proprietary stopper, referred to herein as a “magic cork” 23. With a bottle 30 and a magic cork 23, the user will follow the same procedure discussed above for the Quartina and slide the bottle 30 complete with magic cork 23 into the vessel bay 10a along the rail 11 to engage the vessel dock 12 and the proprietary valve referred to herein as the “magic valve” 13. The Quartina 21 (or bottle 30 and magic cork 23) will engage the vessel dock 12, creating an air-tight seal. Once either the bottle 30 and/or Quartina 21 are in-place in the vessel dock 12, the information display 1 and the PCB board 5 will begin the recognition process and automate the connections 6 to begin sending information from the bay sensors subsystem 7 to the fluid lines subsystem 14. The PCB board 5 will then set the temperature sensor 15 to the appropriate varietal setting and turn on either the cooling pad 16 or warming pad 17 so that the contents of the Quartina 21/bottle 30 is brought to the correct temperature. For example, if the user inserts a Cabernet Sauvignon and the current ambient temperature is 75 degrees and the PCB board 5 determines that the pre-set temperature for said liquid should pour at 59 degrees, the PCB Board 5 will activate the cooling pad 16 to drop the liquid from 75 degrees to 59 degrees prior to pouring from the fluid line 19. Once the temperature is at the predetermined temperature (as determined by the PCB 5 via an input from the temperature sensor 15), the PCB 5 causes the sensor lights 25 to turn on to indicate to a user that the liquid is ready to pour.

In order to pour the liquid from either a Quartina 21 or bottle 30, the user will press the faucet 26 to start the in-line pump 18. The in-line pump 18 will push the liquid from the vessel through the fluid line 19, then through the warming pad 17 and cooling pad 16 to effect the temperature (as discussed above) and the liquid will come through the magic valve 13 and out the faucet 26 as expected and set by the system. As liquid is depleted from the vessels, the PCB 5 tracks released pressure and depletion rate from information from the weight sensor cell 9. Depletion will be tracked from the weight sensor 9 to the corresponding sensor lights 25 on the top of the system exterior casing 28 to indicate decreasing volume levels in the system. The PCB board 5 will transmit date, time and consumption rates back to the cloud computer/application 31 and track consumer drinking patterns. The cloud computer/application 31 will synchronize with the user's application 32 and notify the user of volumes remaining in the system 100. The user may interact with its application 32 and indicate its taste preferences through the IOT library of wines 34 and the digital sommelier 35 will curate recommended selections based on user input and consumption patterns.

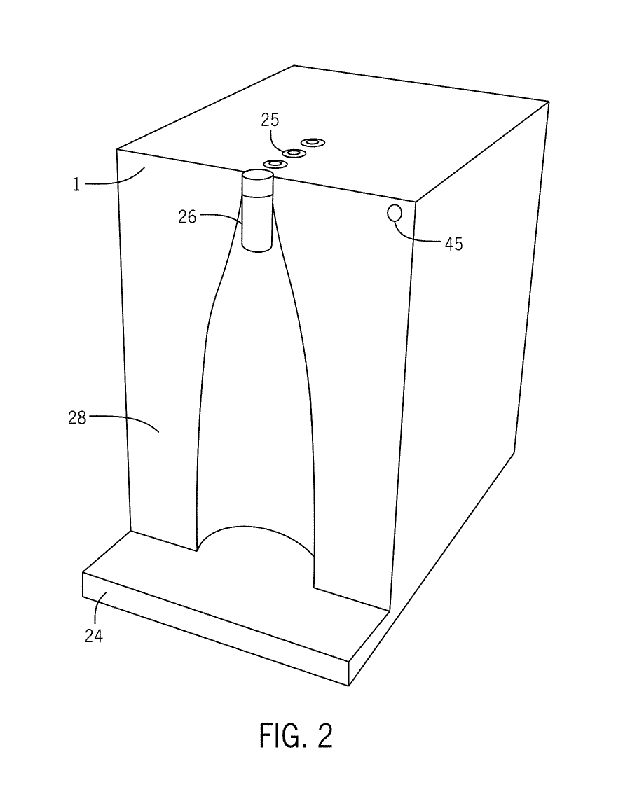

FIG. 2 illustrates an external view of the system 100. The exterior casing 28 will be made up of e.g., eco-friendly plastics and composite wood material. The front cover 19 folds out exposing the internal components of the system 100 with a direct line to the vessel bay 10 for easy, single-handed insertion of either a Quartina 21 or a bottle 30. The exterior casing 28 exhibits an on/off button 45, a faucet 26 for pouring liquid, a fold down drip tray 24 to collect any liquid that drips from the faucet 26 during or following pouring. The volume sensor lights 25 indicate liquid levels remaining in each of the vessel chambers. The information display 1 provides e.g., information as dictated by the user, including but not limited to brand, varietal, temperature, volume remaining and appellation.

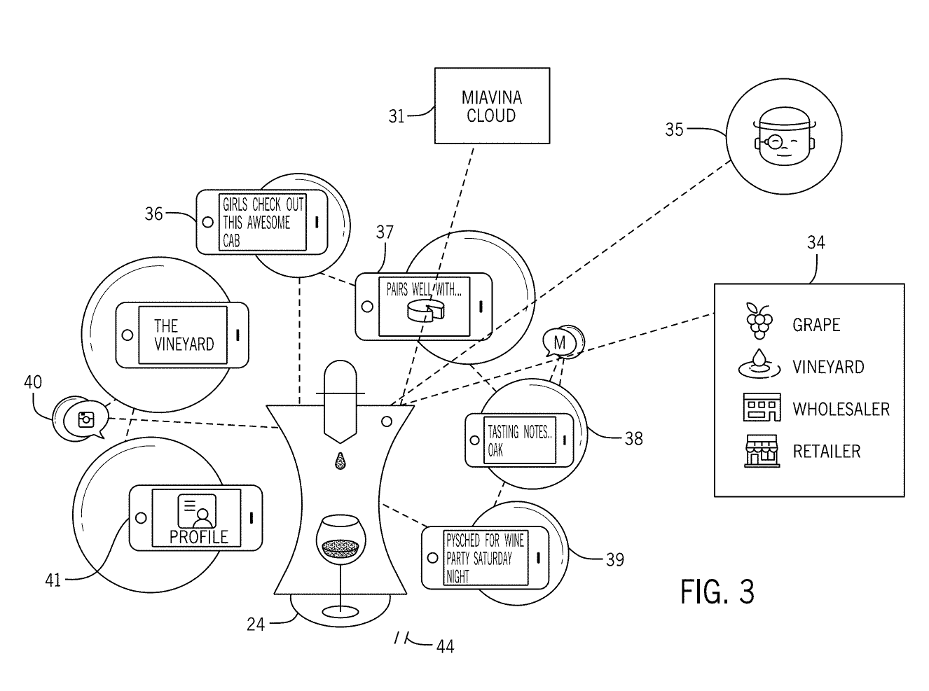

FIG. 3 illustrates the user digital/software application 32, which may also be implemented as a website and accessed by a computing device and/or portable user device. The content is the same through both platforms. Once the power cord 27 is plugged in and the system 100 is turned on, the PCB Board 5 will transmit a Wi-Fi signal to any Wi-Fi device within a close proximity to the system. The Wi-Fi Signal 44 will notify the user device 32 that a system is in close range and prompt the user to engage with that particular system. The user may synchronize its device with the system 100 and will be funneled through a general user set-up to generate a unique profile 41, including data inputs such as e.g.,: age, gender, zip, preferences on varietals, brands and regions. Once user preferences are entered and user set-up is complete, the system 100, via it's Wi-Fi connection 44 and it's PCB board 5, will start collecting data and periodically transmitting it back to the cloud computer/application 31. As data accumulates, the IOT library 34 will build its catalog of information, refine assortments and prompt the digital sommelier 35 to begin making wine recommendations 36, food and wine pairings 37, offer tasting notes 38, recommend Geo-located events 39 and on-premises tastings and allow the user to load images 40 to social media accounts and other connected third party sites.

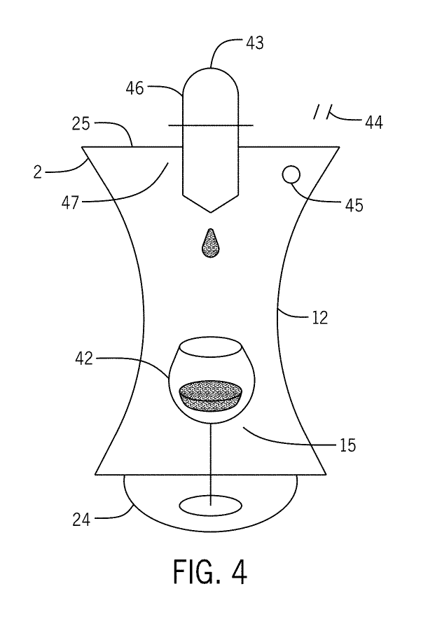

FIG. 4 illustrates details of some of the features of the system 100 disclosed herein. The vessel entrance 2 is a lightweight cover that lifts up easily exposing the vessel bay 10 for product insertion. There is a drip tray 24 to catch any over pouring or drips from the faucet 26. The volume sensor lights 25 display liquid volume levels and automatically adjust as product is depleted. The built-in aerator 46 introduces oxygen to the wine as it is poured to allowing for an ‘opening’ or ‘breathing’ process to the wine to highlight tasting notes. The micro-chip set 42 measures sulfur and oxygen levels to indicate the stability of the product. The kinetic pour 43 mechanism simulates the pouring of wine at an angle to resemble that of the bottle pour. The Wi-Fi connectivity allows the PCB board 5 to communicate system interactions back to the cloud computer/application 31. The vessel dock subsystem 12 creates an oxygen impermeable seal to each package creating a source of pressure and wine stabilization. The temperature system 15 monitors liquid temperature and automatically sets each chamber to the pre-set temperature suggested for unique varietals. The on/off button 45 turns the system on and off. The LED lights 47 are vibrant as long as the system is plugged in.

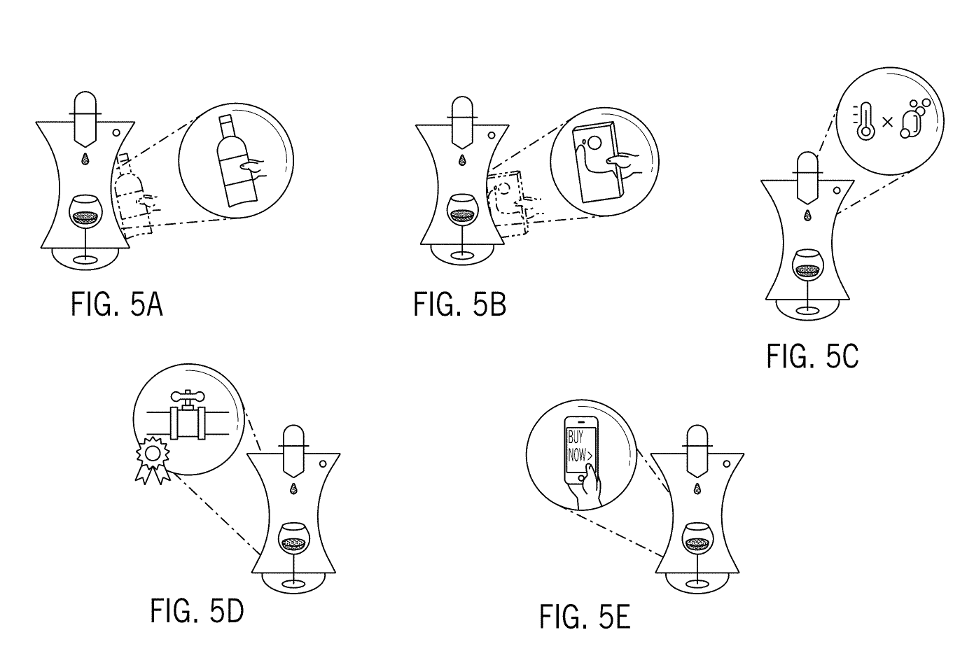

FIG. 5 illustrates various features of the system including: interchangeable package allowance F1, accepting either bottles or quartinas F2, proprietary sustainable wine pods F3, automated temperature and aeration levels F4, direct-to-consumer shipping via in-application purchases F5, extended shelf-life of product through preservation and elimination of oxygen introduction.

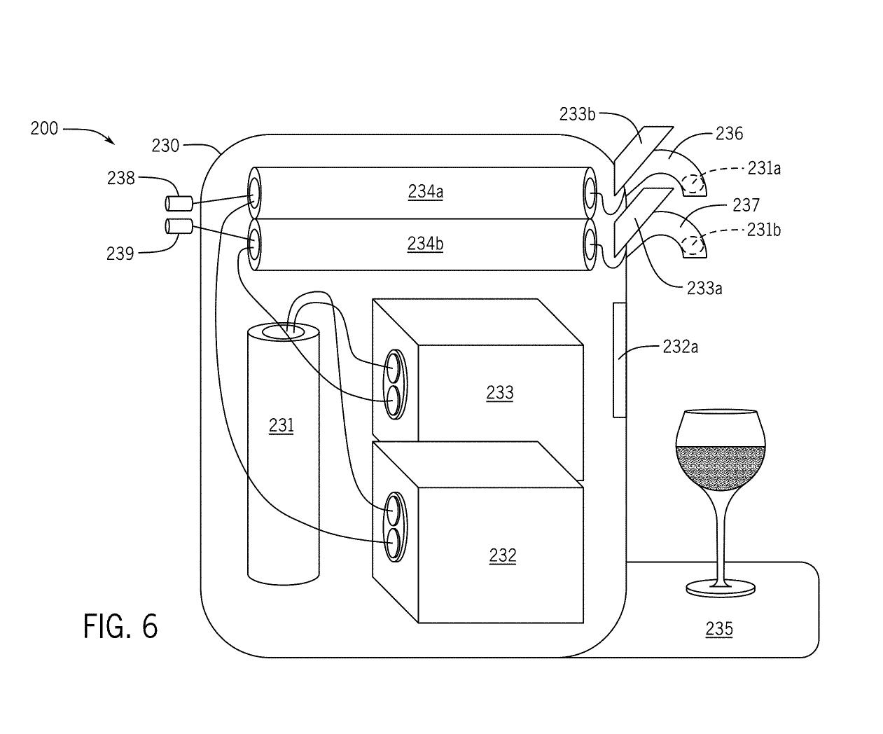

FIG. 6 illustrates a second system 200 disclosed herein. The illustrated system uses a nitrogen tank 231 for wine preservation and propulsion. The tap-wine dispenser casing 230 houses the internal parts of the system including the nitrogen tank 231, a first Quartina 232 for holding a first liquid/wine and a second Quartina 233 for holding a second liquid/wine. Both chambers have unique temperature settings including cooling chamber 234a for the first liquid/wine and cooling chamber 234b for the second liquid/wine. The first liquid/wine will pass over a micro-chip set 231a while the second liquid/wine will pass over micro-chip set 231b. The first liquid/wine and the second liquid/wine will pass through separate nozzles—i.e., faucet 236 for the first liquid/wine and faucet 237 for the second liquid/wine. There is a drip tray 235 to catch over-pouring and drips. Each chamber has a temperature gauge 238 for chamber 1 and temperature gauge 239 for Chamber 2. There is an exterior data screen 232a for displaying product information such as e.g., wine name/type, temperature, volume, etc. Wine is released when a user pulls lever 233a (for the first liquid/wine) and/or lever 2 233b (for the second liquid/wine).

It should be appreciated that the disclosed embodiments can come in various package sizes, including but not limited to: a 2-Liter Quartina, 5-Liter Quartina, 10-Liter Quartina and 20-Liter Quartina. These packages are intended to hold wine, beer, spirits, mixed drinks and non-alcoholic beverages including: water, milk and juice. As such, the disclosed embodiments are not to be limited to dispensing wine.

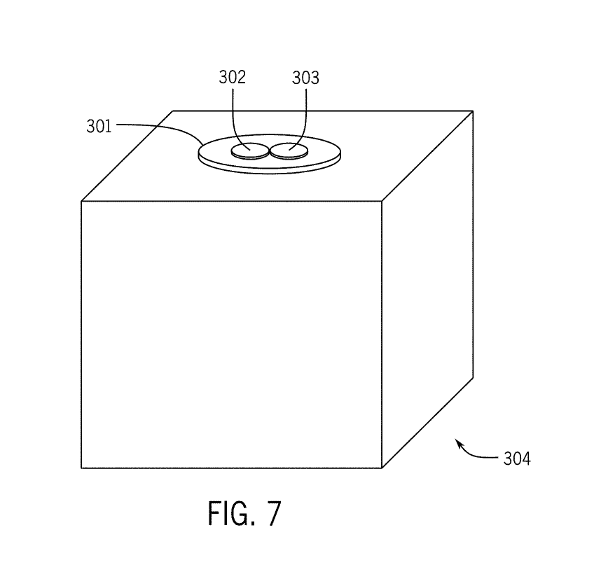

FIG. 7 illustrates the side-view of an example Quartina 304. The Quartina 304 includes a gas-in line 302. Still liquids will use an inert gas like nitrogen or argon and carbonated liquids will use carbon dioxide or compounds including carbon dioxide. The Quartina has a valve 301 and a liquid out-line 303. Sizes for the Quartina 232, 233 that are appropriate for the commercial consumers include e.g., a 2-Liter Quartina, 5-liter Quartina, 10-liter Quartina and 20-liter Quartina.

It should be appreciated that the disclosed Quartina embodiments can come in various small, consumer oriented package sizes including: a 1.5 L Quartina, 1 Liter Quartina, 750 ML Quartina, 500 ML Quartina, and 375 ML Quartina. Quartina's are made up of eco-friendly recyclable material and offer extended shelf-life to wines by using and oxygen impermeable seal.

It should be appreciated that the disclosed embodiments that the disclosed embodiments should not be limited to use with two vessels (or to the dispensing of two liquids). As can be appreciated, the disclosed systems could contain a vessel bay subsystem that only contains one vessel dock and would accommodate only one vessel. In this configuration, the dispenser would have only one spout and the other subsystems could contain just the components needed to accommodate one vessels. As can also be appreciated, the disclosed systems could contain a vessel bay subsystem that contains more than two vessel docks and would accommodate more than two vessels. In this configuration, the dispenser would have a corresponding number of spouts and the other subsystems would contain sufficient components to accommodate more than two vessels.

It should be appreciated that the disclosed embodiments offer several features and advantages. For example, the systems will capture certain sensory elements that simulate the same effects from a bottle pour. As with the pour from a bottle, the liquid as it leaves the system will hit the glass at a certain rate, vs. a mechanical pressurized tap approach. The aural sensation of using a manual aerator in which the user can actually hear the aeration process. The tasting notes from the label and romantic design will be replicated in the app and on the system screen.

The technology disclosed herein may include e.g., an on-off button with LED lighting; finger print scanner that recognizes users and syncs with each user handheld application; drip tray drops down automatically when system is turned on; an LED logo; dual-zone temperatures for both Quartinas and/or bottles, allowing for one red wine and one white wine or two reds and two whites (e.g., flash-chill, refrigeration, etc.); Bluetooth or wireless technology to interact directly with the users phone or tablet; UCC, RFID, Barcode or NFC technology for the Quartina reader/scanner to automatically synchronize with the system when the user inserts a new vessel; kinetic pour mechanism; pressurized seal for spout of Quartina to system as engaged with vessel dock; measured pour by weight; measured depletion rate and corresponding indicator on the system; pump system for extraction and preservation of wine; and/or a remote on/off feature to initialize the chiller from dormant state or ambient temperature (and for energy conservation).

The disclosed embodiments may provide one or more of the following application and/or data functions: all data collected is stored in a connected cloud server; all data for each unique system and user is stored in the system PCB and synced to the Cloud then directly to the user app to track history, product usage, identifying varietals and wine styles that the user likes/dislikes; if the user likes this, then the user will “like” that feature; social networking to allow users to find other system users with GPS locators (coordinate events, make product recommendations, schedule tastings and in-home parties with other system users, etc.); re-order wines; order sample packs; push notifications of flash-flash sales, promotions, wine clubs, members-only events, etc.; and/or a chat function (e.g., “ask a sommelier”—ask questions to in-house sommeliers about winemaking, products, taste profiles, etc.).

The disclosed embodiments may provide one or more of the following Quartina insertion an locking mechanisms: a claw locking mechanism to hold Quartina in place from the bottom at the vessel dock; front covert trap-door to open and insert from the top; sliding vessel rail allows easy insert and remove new/empty Quartinas; second locking mechanism in the form of a clamp, lever or pushing motion to keep Quartina firmly in place; and/or a lever that initiates the engagement liquid/air line-in and liquid line-out.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A liquid dispensing system comprising:
a housing;
a vessel fluidly connected to the housing and containing a liquid;
a preservation subsystem positioned within the housing and in fluid communication with the vessel, wherein the preservation subsystem reduces oxidation of the liquid within the vessel; and
a liquid outlet operably connected to the housing and in fluid communication with the vessel.

2. The liquid dispensing system of claim 1, wherein the preservation subsystem comprises an oxygen impermeable valve, wherein the valve is coupled to a vessel outlet, wherein liquid flows from the vessel through the valve to the liquid outlet of the housing.

3. The liquid dispensing system of claim 1, wherein the preservation subsystem further comprises:
a gas source; and
a gas line coupled to the gas source, wherein the gas line is in fluid communication with the vessel and to dispense the liquid from the liquid outlet of the housing, gas is propelled from the gas source into the vessel.

4. The liquid dispensing system of claim 3, wherein the gas is at least one of nitrogen or carbon dioxide.

5. The liquid dispensing system of claim 1, further comprising:
at least one fluid line in fluid communication with the vessel and the liquid outlet; and
a pump coupled to the housing and in fluid communication with the at least one fluid line, wherein the pump moves the liquid from the vessel to the liquid outlet through the at least one fluid line.

6. The liquid dispensing system of claim 5, wherein the pump is activated by a user control.

7. The liquid dispensing system of claim 5, further comprising:
a temperature sensor that detects a current liquid temperature of the liquid;
a temperature modification subsystem; and
a computing subsystem in electrical communication with the temperature sensor and the temperature modification subsystem, wherein the computing subsystem:
compares the current liquid temperature to a desired liquid temperature; and
generates instructions for the temperature modification subsystem to modify a temperature of the liquid based on the desired liquid temperature; and
transmits the instructions to the temperature modification subsystem.

8. The liquid dispensing system of claim 7, wherein the temperature modification subsystem either heats or cools the liquid before the liquid reaches the liquid outlet based on the instructions.

9. The liquid dispensing system of claim 7, wherein the temperature modification subsystem comprises at least one of a cooling pad or a heating pad, wherein the at least one cooling pad or heating pad is coupled to a fluid line positioned between the vessel and the liquid outlet and when activated selectively transfers heat to or from the liquid.

10. The liquid dispensing system of claim 7, wherein the desired temperature information is received from a user or a database containing temperature preset information of a plurality of liquids.

11. The liquid dispensing system of claim 1, further comprising:
a temperature sensor that detects a current liquid temperature of the liquid;
a computing subsystem in electrical communication with the temperature sensor;
a user display, wherein the user display is in electrical communication with the computing system and displays temperature information to a user;
a user control to adjust the current liquid temperature based on user preferences.

12. A fluid dispensing system comprising:
a housing;
a container holding a fluid and coupled to the housing;
a fluid-propulsion subsystem operably connected to the housing; and
a fluid line in fluid communication with the container and the fluid-propulsion subsystem;
a temperature sensor coupled to the fluid line and operable to detect a current temperature of the liquid;
a temperature modification subsystem operably coupled to the housing;
a computing subsystem in electrical communication with the temperature sensor and the temperature modification subsystem; and
a dispenser in fluid communication with the fluid line; wherein
the computing subsystem activates the temperature modification subsystem to adjust a temperature of the liquid when the current temperature does not match a desired temperature; and
when the dispenser is activated, the fluid-propulsion system propels the fluid from the container to the dispenser.

13. The fluid dispensing system of claim 12, wherein the temperature modification subsystem comprises:
at least one heating pad; and
at least one cooling pad.

14. The fluid dispensing system of claim 12, wherein the fluid-propulsion subsystem comprises:
a gas source; and
a gas line coupled to the gas source, wherein the gas line is in fluid communication with the container and to expel the fluid from the dispenser, gas is propelled from the gas source into the container.

15. The fluid dispensing system of claim 14, wherein the gas is at least one of nitrogen or carbon dioxide.

16. The fluid dispensing system of claim 12, wherein the fluid-propulsion subsystem comprises a pump.

17. The fluid dispensing system of claim 12, wherein when the dispenser is activated, the fluid-propulsion subsystem creates a suction that pulls the fluid from the container to the dispenser.

18. The fluid dispensing system of claim 12, further comprising a preservation subsystem positioned within the housing and in fluid communication with the container, wherein the preservation subsystem reduces oxidation of the fluid within the container.

19. The fluid dispensing system of claim 12, wherein the housing further comprises a user display, wherein the user display is in electrical communication with the computing subsystem and displays data to a user.

20. A liquid preservation and dispensing system comprising:
a container holding a liquid;
a vessel, wherein the vessel receives and engages with the container, wherein the engagement prevents oxygen from contacting the liquid;
a gas inlet valve on the container that enables a gas to enter the container when the inlet valve is in an open position;
a liquid outlet valve on the container that enables the liquid to leave the container when the outlet valve is in an open position;
a handle operably connected to the inlet and outlet valves, wherein the handle opens or closes the inlet and outlet valves; and
a dispenser in fluid communication with the container, wherein the dispenser receives the liquid and introduces the liquid to oxygen.

21. The liquid preservation and dispensing system of claim 20, wherein the gas is nitrogen.

22. The liquid preservation and dispensing system of claim 20, wherein the dispenser further comprises an aerator to accelerate introduction of oxygen to the liquid.
